(19) United States
(12) Patent Application Publication
(10) Pub. No.: US 2026/0152977 A1
(43) Pub. Date: Jun. 4, 2026

(54) LOCKING DEVICE FOR AN AIRCRAFT DOOR, WITH DOUBLE C-SHAPED LATCH

(71) Applicant: Airbus Operations SAS, Toulouse (FR)

(72) Inventors: Jerome PHALIPPOU, Toulouse (FR); Laurent TIZAC, Toulouse (FR); Patrick LIEVEN, Toulouse (FR); Arnaud TONNELE, Toulouse (FR); Frederic BROCHARD, Toulouse (FR)

(21) Appl. No.: 19/401,590

(22) Filed: Nov. 26, 2025

(30) Foreign Application Priority Data
Nov. 29, 2024 (FR) FR2413242

(51) Int. Cl. E05B 83/02; B64C 1/14

(52) U.S. Cl. CPC E05B 83/02; B64C 1/1415; B64C 1/1423

(57) ABSTRACT

A locking device for a door of an aircraft has a male part and a female part. The male part has a rod extending along a longitudinal axis. The female part extends along a longitudinal axis. The female part has a housing for the male part and first and second locks for locking the male part, referred to as C-shaped locks. Each lock has an open ring. The female part is pivotable around the male part between an unlocking position of the door and a locking position of the door. The longitudinal axis of the male part and the longitudinal axis of the female part coincide in the locking position. The first and second locks are positioned on either side of an intermediate region of the rod in the locking position.

### CROSS-REFERENCES TO RELATED APPLICATIONS

This Application claims the benefit of French Patent Application Number 2413242 filed on Nov. 29, 2024, the entire disclosure of which is incorporated herein by way of reference.

### FIELD OF THE INVENTION

The present invention relates to a locking device for an aircraft door.

### BACKGROUND OF THE INVENTION

In order to be suitable for use in modern airliners, an aircraft door must satisfy numerous certification requirements and specifications. In particular, the aircraft door must have a locking device that secures the aircraft door in its closed position during aerial navigation of the aircraft. To this end, the door may be fitted with a locking device comprising a hook-shaped or C-shaped lock. A C-shaped lock usually has an open ring that rotates about an axis in order to lock and unlock the door. Nevertheless, such a C-shaped lock generates lever arms, which create bending moments and subject the aircraft to additional stresses that have to be overcome. On large cargo aircraft doors, the locking devices are subjected to such loading (pressurization, flexing of the fuselage, etc.) that disadvantageous structural reinforcements have to be added, thus making the use of a C shape less attractive than a hook system, for example in terms of weight.

The aim of the invention is to at least partially overcome this drawback.

### SUMMARY OF THE INVENTION

To this end, a locking device for a door of an aircraft is proposed, comprising a first part, referred to as male part, and a second part, referred to as female part, the male part comprising a rod having an intermediate region between two ends and extending along a longitudinal axis, referred to as axis of the male part, the female part extending along a longitudinal axis, referred to as axis of the female part, the female part comprising a housing for receiving the male part, and a first lock and a second lock for locking the male part, referred to as C-shaped locks, each comprising an open ring, the female part being mounted so as to pivot around the male part between an unlocking position of the door, in which the rod is free to be removed from the housing of the female part, and a locking position of the door, in which the rod is held by each of the C-shaped locks in the housing for receiving the male part, the longitudinal axis of the male part and the longitudinal axis of the female part coinciding in the locking position, the C-shaped locks being positioned on either side of the intermediate region of the rod in the locking position.

By virtue of the double C-shaped lock of the device according to the present invention, it is possible to realign fibres of the aircraft door frame and the rod of the male part and eliminate any harmful bending moment. On large cargo doors, for example, the double C-shaped lock avoids the need for structural reinforcements and reduces the weight of the locking device and of the associated fixed structure non-negligibly, while ensuring excellent compactness of the locking device.

According to another aspect, in the locking position, the C-shaped locks are positioned symmetrically on either side of the intermediate region of the rod.

According to another aspect, in the locking position, the C-shaped locks are positioned symmetrically in a plane that is orthogonal to the longitudinal axis of the rod and contains the middle of the rod.

According to another aspect, each of the locks is independent of the other.

According to another aspect, the female part is a cylinder, the housing for receiving the male part extending between the two C-shaped locks, each of the C-shaped locks forming an opposite end of the cylinder.

According to another aspect, the locking device comprises a controller controlling the pivoting of the female part.

According to another aspect, the locking device comprises a locking means for locking the female part in the locking position.

Another subject of the invention is a door assembly, comprising a door fitted with one out of the female part and the male part of the locking device as described above, and a fixed part fitted with the other out of the male part and the female part of the locking device as described above.

According to another aspect, in the locking position, the female and male parts are positioned so as to cancel out any bending moment on the locking device.

Another subject of the invention is an aircraft fitted with a door assembly as described above, the fixed part of the door assembly being a fuselage part of the aircraft.

### BRIEF DESCRIPTION OF THE DRAWINGS

Further features, details and advantages will become apparent upon reading the detailed description below, and analysing the appended drawings, in which:

FIG. 1 is a schematic perspective view of an aircraft door assembly fitted with a locking device according to the present invention.

FIG. 2 is a schematic cross-sectional view of the assembly in FIG. 1 in an open state of the door.

FIG. 3 is a schematic cross-sectional view of the assembly in FIG. 2 in a closed state of the door, the locking device being in a position referred to as unlocked position.

FIG. 4 is a schematic transverse view of the assembly in FIG. 3 in a closed state of the door, the locking device being in a position referred to as unblocked locked position.

FIG. 5 is a schematic transverse view of the assembly in FIG. 4 in a closed state of the door, the locking device being in a position referred to as blocked locked position.

### DESCRIPTION OF THE EMBODIMENTS

The examples and the related conditions detailed here are mainly intended to help the reader understand the principles of the present invention rather than limit its scope to these specific examples and conditions. It will be understood that a person skilled in the art can conceive of various arrangements that, although not explicitly described or depicted here, nevertheless embody the principles of the present invention and are included in its spirit and scope.

Furthermore, for ease of understanding, the following description may describe relatively simplified implementations of the present invention. As a person skilled in the art will understand, other implementations of the present invention may be of greater complexity.

In some cases, examples of modifications of the present invention may also be presented. This is done simply to aid understanding, again rather than define the scope or establish the limits of the present invention. These modifications are not an exhaustive list, and a person skilled in the art may make other modifications while still remaining within the scope of the present invention.

Furthermore, all of the statements below relating to the principles, aspects and implementations of the present invention, as well as the specific examples thereof, aim to encompass both the structural and functional equivalents thereof, whether they are currently known or developed in the future.

As can be seen in the figures, the subject of the invention is a locking device 1 intended to be fitted to an aircraft Ae for closing a door P of the aircraft, as well as a door assembly 100 of the aircraft Ae. Another subject of the invention is the aircraft Ae fitted with the door assembly 100. In the figures, the door assembly comprises a single locking device 1. Nevertheless, the invention is not limited to this configuration, and the door assembly may comprise as many locking devices 1 as necessary.

It should be noted that the present invention applies to the passenger doors and cargo doors of an aircraft, particularly advantageously to a cargo door.

[To make the present description easier to read, an orthonormal reference system (X, Y, Z) has been illustrated in the figures. The X direction corresponds to a pivot axis of the door P, which is preferably, but not restrictively, chosen to be horizontal when the aircraft is on the ground. The Y and Z directions are orthogonal to the X direction, the Z direction being vertical in the horizontal position of the aircraft.

As can be seen from the figures, the locking device 1 comprises a first part 2, referred to as male part, or pin, intended to be secured to a door frame 101 of the assembly 100. The locking device 1 also comprises a second part 3, referred to as female part, intended to be secured to the door P of the assembly 100.

The assembly 100 comprises the locking device 1, the door P and the door frame 101. The door frame comprises a first longitudinal rail 102 of the fuselage F of the aircraft Ae. The rail 102 extends, for example, in a plane (X, Y) and a second rail 103, which forms a non-zero angle with the first rail 102, extending, for example, in a plane (Y, Z).

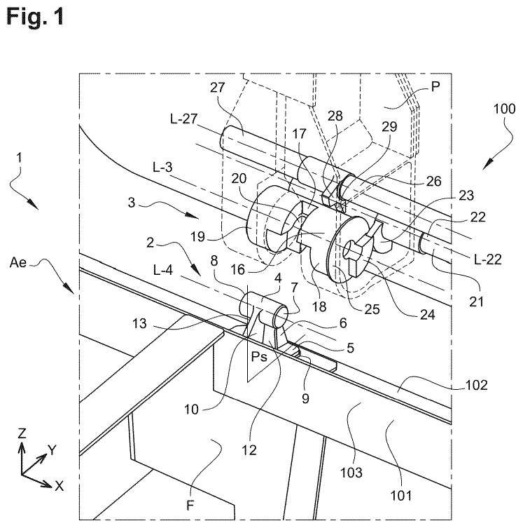

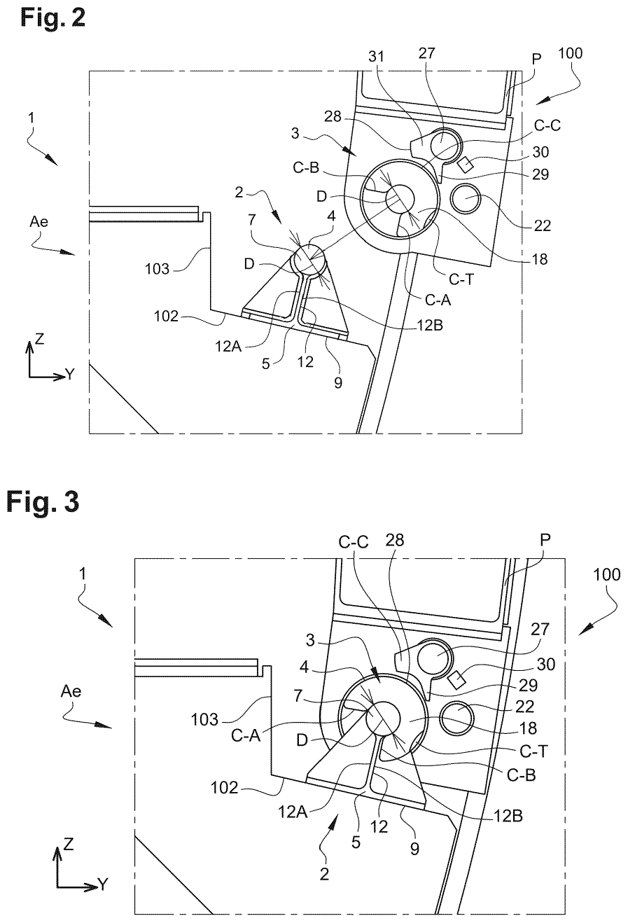

In the figures, the door P is mounted so as to pivot between a state referred to as open state and a state referred to as closed state. In the open state, the door P is positioned at a distance from the frame 101. In the closed state, the door P is positioned against the door frame. The open state is illustrated in FIGS. 1 and 2. The closed state is illustrated in FIGS. 3, 4 and 5.

When the door P is closed, the male part 2 of the locking device 1 is housed in the female part 3 and the female part 3 moves, by rotating, between an unlocking position of the door (FIG. 3) and a locking and blocking position (FIG. 5) of the door, as will be detailed below.

The male part 2 of the locking device 1 is described in detail below.

As can be seen in particular in FIG. 1, the male part 2 comprises a rod 4, which is intended to be housed in the female part 3 of the locking device 1. The male part 2 also comprises a base 5, which is intended to be placed on the rail 102 of the frame 101 of the door P, and an intermediate part 6 for securing the rod 4 to the base 5.

In the figures, the rod 4 is straight, with a longitudinal axis L-4 and a circular cross section, comprising an intermediate region Z extending between two opposite ends 7 and 8. The axis L-4 is preferably parallel to the pivot axis X of the door P. More generally, the orientation of the rod 4 is chosen so that the rod 4 is inserted into the female part 3, as will be detailed below.

In the figures, the base 5 has a flat basic shape, opposite the rod 4, in order to enable the male part 2 to be fastened by any type of means to the rail 102 of the fuselage F, for example by screwing. The part 6 enables the rod 4 to be oriented so that the male part 2 and female part 3 are in an orientation in which the locking device 1 functions, i.e., such that the rod 4 is housed in the female part 3 in the locking position of the locking device.

Advantageously, the locking device 1 comprises a set of shims 9 of different thicknesses for adjusting the male part 2 in the Z direction, and grooved shims (the grooves are not visible in the figures) for adjusting the male part 2 in the Y direction, so as to correctly position the rod 2 relative to the female part 3. Of course, any other suitable adjustment system can be envisaged.

The base 5 is surmounted by the intermediate part 6, which has, non-limitingly, the general shape of a truncated pyramid.

As can also be seen from the figures, the male part 2 comprises a stiffening rib 10 in the form of a fin extending from the middle of the rod 4.

The intermediate part 6 comprises a planar portion 12, the rib 10 extending substantially orthogonally to the portion 12, in a plane (X, Z), between the rib 10 and the end 7.

The intermediate part 6 also comprises a planar portion 13 extending substantially orthogonally to the rib 10, in a plane (X, Z), between the rib 10 and the end 8.

The planar portions 12, 13 are configured to form a support for a respective lock of the female part 3, as will be detailed below. The planar portions 12, 13 are hereinafter referred to as support portions 12, 13. The support portions 12, 13 have a support face A positioned facing the interior of the aircraft Ae, i.e., facing the rail 103, and a support face B positioned facing the exterior of the aircraft Ae. In FIGS. 2 to 5, the faces 12A and 12B of the male part 2 have been referenced.

The female part 3 of the locking device 1 will now be described in detail.

As can be seen in particular in FIG. 1, the female part 3 is intended to be installed in a mount of the door P.

In the embodiment illustrated, the female part 3 is a cylinder comprising a body 16 provided with a central part 17 extending between two opposite ends 18, 19. Each of the ends 18, 19 has the shape of an open ring, in the shape of a C, forming a lock for the male part 2. The central part 17 has the shape of a cylindrical housing 20 dimensioned to receive the rod 4 of the male part 2.

In other words, the body 16 is recessed longitudinally in its central part 17 longitudinally so as to form the two C-shaped locks 18, 19.

L-3 denotes the longitudinal axis of the female part 3.

The cylindrical housing 20 has a diameter D that is substantially equal to the diameter D of the rod 4 so that the rod 4 is held in the female part 3 when the door is closed.

Each of the rings 18, 19 extends orthogonally to the longitudinal axis L-3. In a plane (Y, Z), the opening of each ring 18, 19 is an angular sector forming the C shape of the lock. C-A and C-B denote the two end branches of the C shape, which are connected to one another by a longitudinal contour C-C. The branches C-A and C-B of the lock 18 are configured to cooperate with the support portion 12, as will be detailed below. The longitudinal contour C-C has the shape of a circular arc provided with a recess or indentation C-T in order to cooperate with a locking means of the device 1, as will be detailed below. An internal diameter D of each ring 18, 19 is equal to the diameter of the rod 4 so that, when the male part 2 is installed in the female part 3, the ends 7, 8 of the rod 4 respectively rest in the lock 18, 19.

In the embodiment illustrated, the female part 3 is in one piece, and the locks 18 and 19 are connected to one another. The invention is not limited to this embodiment, and the two locks 18, 19 can be independent of one another.

As can be seen from the figures, the C-shaped locks 18, 19 are positioned on either side of a middle of the rod 4 in the locking position. The C-shaped locks are positioned symmetrically in a plane that is orthogonal to the longitudinal axis of the rod L-4 and contains the intermediate region Z. In the embodiment illustrated, the C-shaped locks are positioned symmetrically in a plane Ps that is orthogonal to the axis of the rod L-4 and contains the middle of the rod.

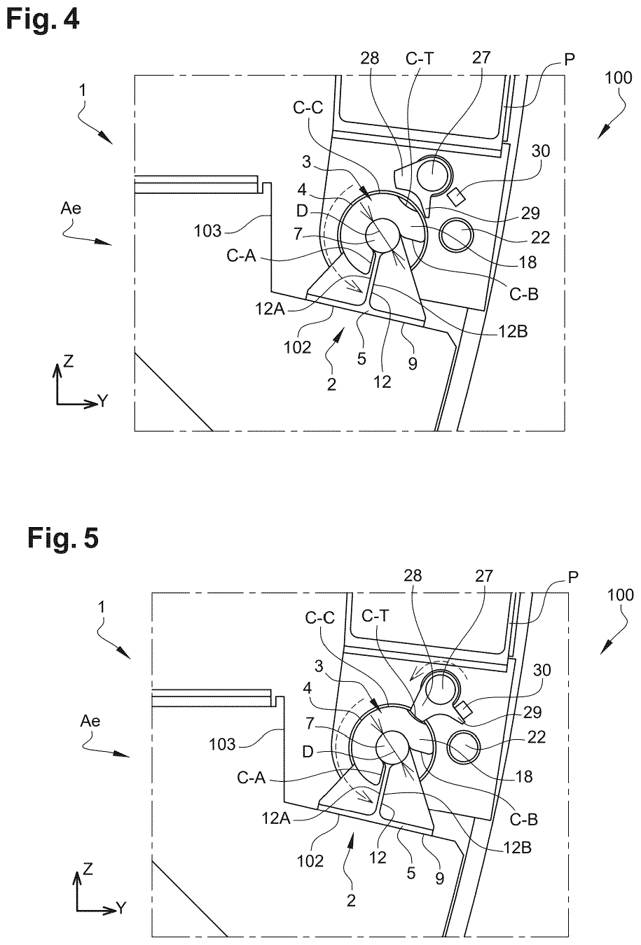

As can be seen from the kinematics in FIGS. 2 to 5, the female part 3 is mounted so as to pivot between the unlocking position of the door P, illustrated in FIGS. 2 and 3, and the locking position of the door P, illustrated in FIGS. 4 and 5.

The locking device 1 comprises a control means 21 for controlling the movement of the female part 3.

In the embodiment illustrated, the control means 21 comprises an actuator 22 in the form of a rod with a longitudinal axis L-22. A toothed angular sector 23 is fastened to the contour of the actuating rod 22. The rod 22 is configured to pivot about its axis L-22, thus causing the angular sector 23 to rotate. The sector 23 is configured to mesh with a toothed angular sector 24 of a wheel 25 secured for conjoint rotation with the female part 3. In the figures, the wheel 25 is secured to the lock 18. The longitudinal axis L-22 is parallel to the longitudinal axis L-3 of the female part 3.

Thus, actuating the rod 22 causes each of the locks 18, 19 to rotate about the longitudinal axis L-3 of the female part 3 between the unlocked position, in which the branch C-B of the C shape faces the face B of the respective planar portion 12, 13, and the locked position, in which the branch C-A of the C shape faces the face A of the respective portion 12, 13.

It should be noted that, for an embodiment in which the locks 18, 19 are independent, the control means has to control the rotation of each of the locks 18, 19.

It should also be noted that the invention is not limited to a control using meshed toothed wheels and also includes any type of control that enables the locks 18, 19 to pivot about the axis L-3.

As can also be seen in the figures, the locking device 1 also comprises a blocking means 26 for blocking each of the locks 18, 19 in the locked position.

The blocking means 26 comprises a locking shaft or rod 27 with a longitudinal axis denoted L-27. Preferably, the axis L-27 is parallel to the axis L-22. The shaft 27 is configured to rotate about its longitudinal axis L-27. The shaft 27 has a detent 28, the shape of which matches the shape of the indentation C-T in the lock 18, so that the detent 28 is positioned in the indentation C-T in the lock 18 when the locking device is in the blocking position, as will be explained. The blocking means 26 also comprises a movement limiter 29 configured to be stopped by a stop 30 in the locking and blocking position of the locking device 1.

In the embodiment illustrated, and non-limitingly, the detent 28 and the movement limiter 29 are lugs projecting radially from the same component 31. The component 31 is secured for conjoint rotation with the shaft 27.

Thus, actuating the blocking means 26 causes the component 31 to rotate orthogonally to the axis L-27, thus causing the lugs 28, 29 to pivot between an unblocking position of the device 1, in which the lugs 28, 29 are at a distance from the indentation C-T and from the stop 30, respectively, and a blocking position, with the lug 28 being positioned in the indentation C-T and the lug 29 stopped against the stop 30, the control means 20 having previously pivoted into the locking position.

When there are two independent C-shaped locks, two detents are required.

Thus, pivoting the control means 22 moves the locking device 1 between the unlocking position (FIGS. 1 to 3) and the locking position (FIGS. 4 and 5), and the blocking means 26 moves the locking device 1 between the unblocking position (FIGS. 1 to 4) and the blocking position (FIG. 5).

It should be noted that the invention is not limited to the blocking means illustrated, and any other suitable means may be used. For example, the lugs 28 and 29 may be separated from one another and independently attached to the rod 27.

The device 1 according to the present invention is at once compact, simple (with few components) and lightweight. The device 1 according to the present invention transforms the lock of the door P into a “T-shaped” lock, thus making it possible to use the double C-shaped lock, aligning the natural fibres of the frame F with the device 1 and avoiding generating bending moments. The device 1 operates in pure tension. By virtue of the device 1, it is possible to avoid the use of reinforcements on the C-shaped locks and on the fixed structure, thereby reducing the mass of the device 1 while maintaining the compactness of the lock of the door P.

Modifications and improvements to the above-described implementations of the present invention may become apparent to a person skilled in the art. In particular, the embodiments and variants described can be combined, provided that they are not incompatible. The above description is illustrative by means of examples rather than limiting. The scope of the present invention is therefore limited solely by the scope of the claims below.

What is claimed is:

1. A door assembly comprising:
an aircraft door comprising:
a male part; and
a female part,
wherein the male part comprises a rod having an intermediate region between two ends and extending along a longitudinal axis of the male part, the female part extending along a longitudinal axis of the female part,
wherein the female part comprises a housing for receiving the male part, and a first lock and a second lock for locking the male part, the first and second locks being C-shaped locks, each comprising an open ring, the female part being mounted so as to pivot around the male part between an unlocking position of the aircraft door, in which the rod is free to be removed from the housing of the female part, and a locking position of the aircraft door, in which the rod is held by each of the C-shaped locks in the housing for receiving the male part, the longitudinal axis of the male part and the longitudinal axis of the female part coinciding in the locking position, the C-shaped locks being positioned on either side of the intermediate region of the rod in the locking position, the aircraft door being fitted with one out of the female part and the male part of the locking device, and a fixed part being fitted with the other out of the male part and the female part of the locking device.

2. The door assembly according to claim 1, wherein, in the locking position, the C-shaped locks are positioned symmetrically on either side of the intermediate region of the rod.

3. The door assembly according to claim 2, wherein, in the locking position, the C-shaped locks are positioned symmetrically in a plane that is orthogonal to the longitudinal axis of the rod and contains the middle of the rod.

4. The door assembly according to claim 3, wherein each of the locks is independent of the other.

5. The door assembly according to claim 4, wherein the female part is a cylinder, the housing for receiving the male part extending between the two C-shaped locks, each of the C-shaped locks forming an opposite end of the cylinder.

6. The door assembly according to claim 5, further comprising a control means for controlling the pivoting of the female part.

7. The door assembly according to claim 6, further comprising a locking means for locking the female part in the locking position.

8. The door assembly according to claim 7, wherein, in the locking position, the female and male parts are positioned so as to cancel out any bending moment on the locking device.

9. Aircraft fitted with a door assembly according to claim 1, the fixed part of the door assembly being a fuselage part of the aircraft.
